(19) United States
(12) Patent Application Publication
(10) Pub. No.: US 2024/0348397 A1
(43) Pub. Date: Oct. 17, 2024

(54) UPLINK COORDINATED TRP DETERMINATION METHOD AND APPARATUS, AND STORAGE MEDIUM

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 18/294,409

(22) PCT Filed: Aug. 4, 2021
(86) PCT No.: PCT/CN2021/110664

§ 371 Date: Feb. 1, 2024

(51) Int. Cl. H04L 5/00; H04B 7/06; H04W 72/1268; H04W 80/02

(52) U.S. Cl. CPC H04L 5/0051; H04B 7/0626; H04W 72/1268; H04W 80/02

(57) ABSTRACT

The present disclosure relates to an uplink coordinated TRP determination method and apparatus, and a non-transitory storage medium. The uplink coordinated TRP determination method is performed by a network device. The method includes: on the basis of one or more SRS resource sets, configuring and determining the transmission direction of one or more TRPs, wherein the transmission direction of the one or more TRPs is used for determining coordinated TRPs, and the coordinated TRPs are TRPs which are used by a terminal to coordinately transmit a PUSCH in a plurality of TRP transmission directions.

### CROSS-REFERENCE TO RELATED APPLICATIONS

The present application is a U.S. National Stage of International Application No. PCT/CN2021/110664, filed on Aug. 4, 2021, the contents of which are incorporated herein by reference in their entireties for all purposes.

### BACKGROUND

### Technical Field

The present disclosure relates to the field of communication technologies, and in particular to a method and apparatus for determining an uplink coordinated TRP, and a non-transitory storage medium.

### Description of the Related Art

With the development of communication technologies, beam-based transmission and reception need to be used in order to ensure coverage. When a network device (such as a base station) has a plurality of Transmission Reception Points (TRPs), a multi-TRP/PANEL may be used to provide services to terminals. The application of the multi-TRP/PANEL in the network device is mainly to improve the coverage at cell edges, provide a more balanced service quality in a service area, and coordinately perform data transmission between the multi-TRP/PANEL in different manners. From the perspective of network form, the network deployment is performed in a manner of a large number of distributed access points plus centralized baseband processing, which will be more conducive to providing a balanced user experience rate, and significantly reduce the delay and signaling overhead caused by handover across cells. With the coordination between the multi-TRP/PANEL, channel transmission/reception is performed from a plurality of beams with a plurality of angles, better overcoming various occlusion/blocking effects and ensuring the robustness of link connections, which is suitable for Ultra Reliable Low Latency Communication (URLLC) services to improve transmission quality and meet reliability requirements.

In the R16 study stage, based on the application of coordinated multipoint transmission technologies between downlink multi-TRP/PANEL, transmission enhancement is performed for a Physical Downlink Shared Channel (PDSCH). Since the data transmission includes scheduling feedback on uplink and downlink channels, only enhancing the downlink data channel in the research of URLLC cannot guarantee service performances. Therefore, in the research of R17, a Physical Downlink Control Channel (PDCCH), a Physical Uplink Control Channel (PUCCH) and a Physical Uplink Shared Channel (PUSCH) are continued to be enhanced.

In a multi-TRP-based uplink enhancement scheme, a plurality of coordinated TRPs in a multi-TRP-oriented uplink transmission are first scheduled by the network device and then configured to the terminal through a Sounding Reference Signal (SRS) resource set. Each resource set is associated with an antenna panel transmission direction or a TRP transmission direction, and each resource is associated with a specific beam direction. The transmission of the PUSCH is performed between the configured coordinated TRPs, and dynamic handover of a single TRP transmission state and a multi-TRP transmission state is also supported.

In the New Radio (NR), a coordinated TRP configuration used for an uplink transmission is a fixed TRP semi-statically configured by the network through a Radio Resource Control (RRC) signaling.

### SUMMARY

The present disclosure provides a method and apparatus for determining an uplink coordinated TRP, and a non-transitory storage medium.

According to a first aspect of embodiments of the present disclosure, there is provided a method for determining an uplink coordinated TRP, which is performed by a network device. The method includes configuring and determining, based on one or more SRS resource sets, one or more TRP transmission directions, wherein the one or more TRP transmission directions are configured to determine a coordinated TRP, and the coordinated TRP is a TRP used by a terminal to coordinately transmit a PUSCH towards a plurality of TRP transmission directions.

According to a second aspect of embodiments of the present disclosure, there is provided a method for determining an uplink coordinated TRP, which is performed by a terminal. The method includes: determining, based on one or more SRS resource sets, a coordinated TRP transmission direction for coordinately transmitting a PUSCH towards a plurality of TRP transmission directions, and a coordinated TRP, wherein the coordinated TRP is a TRP used by the terminal to coordinately transmit the PUSCH towards the plurality of TRP transmission directions.

According to a third aspect of embodiments of the present disclosure, there is provided an apparatus for determining an uplink coordinated TRP, including:
a processor; and a memory configured to store instructions executable by the processor;
wherein the processor is configured to execute the method for determining the uplink coordinated TRP described in the first aspect or any implementation of the first aspect.

According to a fourth aspect of embodiments of the present disclosure, there is provided an apparatus for determining an uplink coordinated TRP, including a processor and a memory configured to store instructions executable by the processor. The processor is configured to execute the method for determining the uplink coordinated TRP described in the second aspect or any implementation of the second aspect.

According to a fifth aspect of embodiments of the present disclosure, there is provided a non-transitory storage medium having instructions stored thereon, wherein the instructions in the non-transitory storage medium, when executed by a processor of a network device, enable the network device to perform the method for determining the uplink coordinated TRP described in the first aspect or any implementation of the first aspect.

According to a sixth aspect of embodiments of the present disclosure, there is provided a non-transitory storage medium having instructions stored thereon, wherein the instructions in the non-transitory storage medium, when executed by a processor of a terminal, enable the terminal to execute the method for determining the uplink coordinated TRP described in the second aspect or any implementation of the second aspect.

It should be noted that the above general description and the following detailed description are merely exemplary and explanatory and should not be construed as limiting of the disclosure.

### BRIEF DESCRIPTION OF THE DRAWINGS

The accompanying drawings here, which are incorporated in and constitute a part of this specification, illustrate embodiments consistent with the present disclosure and together with the description serve to explain principles of the present disclosure.

FIG. 1 shows a schematic diagram of a wireless communication system according to an embodiment of the present disclosure.

FIG. 2 shows a flowchart of a method for determining an uplink coordinated TRP according to an embodiment of the present disclosure.

FIG. 3 shows a flowchart of a method for determining an uplink coordinated TRP according to an embodiment of the present disclosure.

FIG. 4 shows a flowchart of a method for determining an uplink coordinated TRP according to an embodiment of the present disclosure.

FIG. 5 shows a flowchart of a method for determining an uplink coordinated TRP according to an embodiment of the present disclosure.

FIG. 6 shows a flowchart of a method for determining an uplink coordinated TRP according to an embodiment of the present disclosure.

FIG. 7 shows a flowchart of a method for determining an uplink coordinated TRP according to an embodiment of the present disclosure.

FIG. 8 shows a flowchart of a method for determining an uplink coordinated TRP according to an embodiment of the present disclosure.

FIG. 9 shows a flowchart of a method for determining an uplink coordinated TRP according to an embodiment of the present disclosure.

FIG. 10 shows a flowchart of a method for determining an uplink coordinated TRP according to an embodiment of the present disclosure.

FIG. 11 shows a flowchart of a method for determining an uplink coordinated TRP according to an embodiment of the present disclosure.

FIG. 12 shows a block diagram of an apparatus for determining an uplink coordinated TRP according to an embodiment of the present disclosure.

FIG. 13 shows a block diagram of an apparatus for determining an uplink coordinated TRP according to an embodiment of the present disclosure.

FIG. 14 shows a block diagram of a device for determining an uplink coordinated TRP according to an embodiment of the present disclosure.

FIG. 15 shows a block diagram of a device for determining an uplink coordinated TRP according to an embodiment of the present disclosure.

### DETAILED DESCRIPTION OF THE PREFERRED EMBODIMENTS

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure.

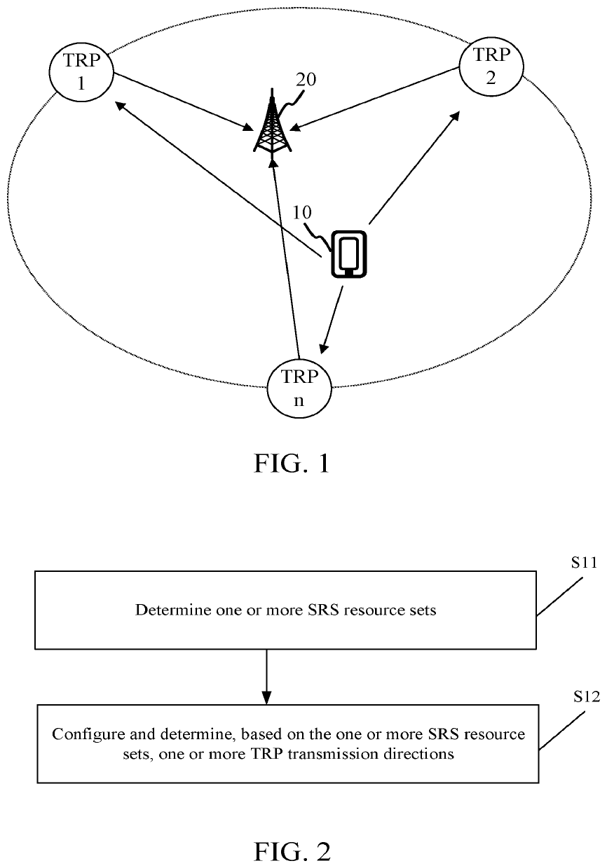

A method for determining an uplink coordinated TRP provided by embodiments of the present disclosure may be performed by a wireless communication system shown in FIG. 1. Referring to FIG. 1, the wireless communication system includes a network device 20 and a terminal 10. The terminal is connected to the network device via a wireless resource and transmits data. Data transmission is carried out between the network device and the terminal based on a beam. A PUSCH uplink transmission enhancement may be performed between the network device and the terminal based on multi-TRP.

It can be understood that the number of TRPs used by the network device to perform the data transmission with the terminal based on the multi-TRP may be one or more. The network device performing the data transmission with the terminal based on TRP1, TRP2 . . . TRPn in the wireless communication system shown in FIG. 1 is only an illustrative description, and is not limited thereto.

It can be understood that a communication system shown in FIG. 1 is merely a schematic illustration, and the wireless communication system may further include other network devices, such as a core network device, a wireless relay device, and a wireless backhaul device, which are not shown in FIG. 1. Embodiments of the present disclosure do not limit the number of network devices and the number of terminals included in the wireless communication system.

It can be further understood that the wireless communication system of embodiments of the present disclosure is a network providing a wireless communication function. The wireless communication system may employ different communication technologies, such as code division a plurality of access (CDMA), wideband code division a plurality of access (WCDMA), time division a plurality of access (TDMA), frequency division a plurality of access (FDMA), orthogonal frequency-division a plurality of access (OFDMA), single carrier FDMA (SC-FDMA), and carrier sense a plurality of access with collision avoidance. According to the capacity, speed, delay and other factors of different networks, the networks may be divided into the 2G (generation) network, the 3G network, the 4G network or the future evolution network, such as the 5G network. The 5G network may also be referred to as a new radio (NR) network. For convenience of description, the present disclosure may sometimes refer to a wireless communication network simply as a network.

Further, the network device involved in the present disclosure may also be referred to as a radio access network device. The radio access network device may be: a base station, an evolved node B, a home base station, an access point (AP) in a wireless fidelity (WIFI) system, a wireless relay node, a wireless backhaul node, a transmission point (TP) or a transmission and reception point (TRP), etc., may also be a gNB in the NR system, or may also be a component or part of devices that constitute the base station. It can be understood that in embodiments of the present disclosure, the specific technologies and specific device forms adopted by the network device are not limited. In the present disclosure, the network device may provide communication coverage for a specific geographical area and may communicate with terminals located within the coverage area (cell). In addition, when the wireless communication system is a vehicle-to-everything (V2X) communication system, the network device may also be a vehicle-mounted device.

Further, the terminal involved in the present disclosure may also be referred to as a terminal device, user equipment (UE), a mobile station (MS), a mobile terminal (MT), etc., and is a device that provides voice and/or data connectivity to a user. For example, the terminal may be a handheld device with a wireless connectivity function, a vehicle-mounted device, etc. At present, some examples of terminals are: mobile phones, customer premise equipment (CPE), pocket personal computers (PPCs), palm computers, personal digital assistants (PDAs), notebook computers, tablet computers, wearable devices, or vehicle-mounted devices, etc. In addition, when the wireless communication system is the vehicle-to-everything (V2X) communication system, the terminal device may also be a vehicle-mounted device. It can be understood that embodiments of the present disclosure do not limit the specific technologies and specific device forms adopted by the terminal.

In the present disclosure, data transmission is performed between the network device and the terminal based on a beam. An uplink transmission between the network device and the terminal may be enhanced based on multi-TRP, that is, the terminal may perform the uplink transmission enhancement in a multi-TRP transmission direction by the use of coordinated multipoint transmission technologies. A plurality of coordinated TRPs in the uplink transmission in the multi-TRP transmission direction are scheduled by a network and then configured to the terminal through an SRS resource set. Each SRS resource set is associated with an antenna panel transmission direction or a TRP transmission direction, and each resource is associated with a specific beam direction. For example, the PUSCH transmission may be performed between the configured coordinated TRP directions, and dynamic switching of a single-TRP transmission state and a multi-TRP transmission state is supported.

In the related arts, a coordinated TRP transmission direction configuration for an uplink transmission is semi-statically configured by the network through a RRC signaling. Therefore, if the coordinated TRP needs to be adjusted, RRC reconfiguration is required to do so. A mechanism of semi-statically configuring the coordinated TRP transmission direction limits the flexibility of service transmission and is not conducive to improving the transmission reliability and mobility of an uplink service.

Embodiments of the present disclosure provide a method for determining an uplink coordinated TRP that enables the dynamic selection of the uplink coordinated TRP transmission direction. In the method, a network device can configure and determine one or more TRP transmission directions based on one or more SRS resource sets, and then determine, based on the one or more TRP transmission directions, a coordinated TRP transmission direction for a terminal to coordinately transmit a PUSCH towards a plurality of TRP transmission directions.

FIG. 2 shows a flowchart of a method for determining an uplink coordinated TRP according to an embodiment of the present disclosure. The method for determining the uplink coordinated TRP may be executed alone or in combination with other embodiments of the present disclosure. As shown in FIG. 2, the method for determining the uplink coordinated TRP is performed by a network device and includes steps S11 and S12.

In the step S11, one or more SRS resource sets are determined.

In embodiments of the present disclosure, the SRS resource set may be configured by the network device to a terminal.

In the step S12, one or more TRP transmission directions are configured and determined based on the one or more SRS resource sets.

The one or more configured and determined TRP transmission directions are used to determine a coordinated TRP, and the coordinated TRP may be understood as a TRP used by the terminal to coordinately transmit a PUSCH towards a plurality of TRP transmission directions.

In embodiments of the present disclosure, the one or more TRP transmission directions are configured and determined based on the one or more SRS resource sets to determine the coordinated TRP transmission direction for the terminal to coordinately transmit the PUSCH towards the plurality of TRP transmission directions, achieving the dynamic selection of the uplink coordinated TRP.

In embodiments of the present disclosure, the determination of the dynamic coordinated TRP transmission direction may be, on the one hand, based on scheduling by the network device, and may also be, on the other hand, based on selection by the terminal.

In the following, a process of determining the dynamic coordinated TRP transmission direction based on the scheduling by the network device is first described.

In an implementation of the present disclosure, a plurality of SRS resource sets may be configured through a higher layer signaling, for example, the plurality of SRS resource sets are configured through a RRC signaling.

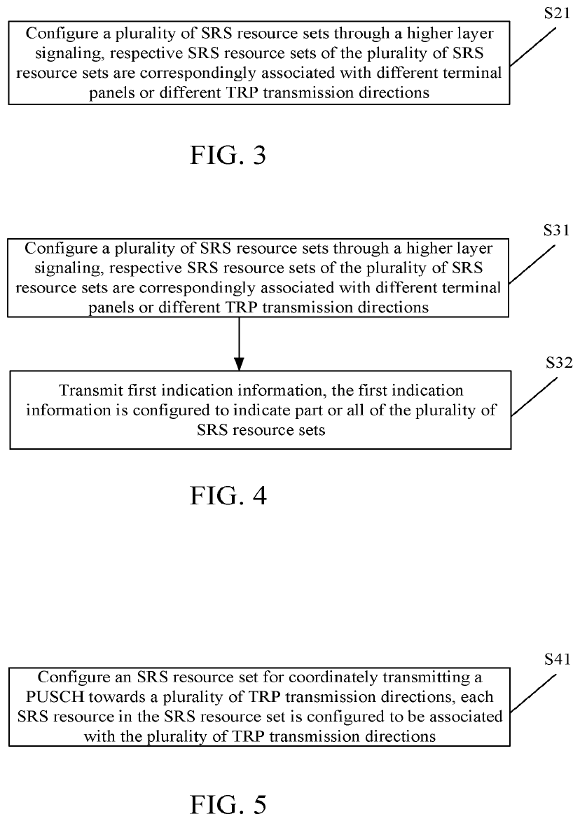

FIG. 3 shows a flowchart of a method for determining an uplink coordinated TRP according to an embodiment of the present disclosure. The method for determining the uplink coordinated TRP may be executed alone or in combination with other embodiments of the present disclosure. As shown in FIG. 3, the method for determining the uplink coordinated TRP is performed by a network device and includes step S21.

In the step S21, a plurality of SRS resource sets are configured through a higher layer signaling.

Respective SRS resource sets of the plurality of SRS resource sets configured by the network device through the higher layer signaling are correspondingly associated with different terminal panels or different TRP transmission directions.

In an embodiment of the present disclosure, one SRS resource set is associated with one terminal panel or one TRP transmission direction, and panels and/or TRP transmission directions associated with different SRS resource sets are different.

In the related arts, an uplink transmission scheme includes two schemes: a codebook-based uplink transmission scheme and a non-codebook-based uplink transmission scheme. In embodiments of the present disclosure, the plurality of SRS resource sets that may be configured through the higher layer signaling may be codebook transmission-based SRS resource sets or may also be non-codebook transmission-based SRS resource sets.

On the one hand, the network device configures a plurality of codebook transmission-based SRS resource sets through the higher layer signaling, and each SRS resource in the codebook transmission-based SRS resource set is configured with corresponding TRP transmission direction indication information. That is, each SRS resource in the codebook transmission-based SRS resource set corresponds to a different terminal antenna panel or a different TRP transmission direction.

The TRP transmission direction indication information can be understood as specific spatial beam indication information in the TRP direction. There may be a plurality of different spatial beams in the same TRP transmission direction. For example, SRS resource set #1 is associated with a TRP1 transmission direction, and TRP transmission direction indication information corresponding to resource 1 in the SRS resource set #1 may be beam 1 in the TRP1 transmission direction, TRP transmission direction indication information corresponding to resource 2 may be beam 2 in the TRP1 transmission direction

In an example, the network device may configure the plurality of codebook-based SRS resource sets through the RRC signaling, which respectively correspond to different terminal antenna panels or different TRP transmission directions. For a codebook-based transmission, an SRS resource set with a function of “codebook” may be configured with a plurality of SRS resources, and each SRS resource is configured with a fixed beam direction (e.g., spatial relation info).

On the other hand, for a non-codebook-based uplink transmission, an SRS resource set with the function of “non-codebook” may be configured with a plurality of SRS resources, and each SRS resource may be configured with a specific beam direction (e.g., spatial relation info), or configured with a Channel State Information (CSI) Reference Signal (RS) associated with a TRP. In embodiments of the present disclosure, the network device configures a plurality of non-codebook transmission-based SRS resource sets through the higher layer signaling, and each SRS resource in the non-codebook transmission-based SRS resource set is configured with corresponding TRP transmission direction indication information, or configured with a CSI-RS associated with a corresponding TRP.

The CSI-RS is associated with the TRP, and accordingly, when the CSI-RS is configured, the TRP associated with the CSI-RS may be determined, without the need of configuring the TRP transmission direction indication information. It can be understood that either the TRP transmission direction indication information or the CSI-RS associated with the TRP is configured, rather than both TRP transmission direction indication information and the CSI-RS associated with the TRP being configured.

In embodiments of the present disclosure, the network device may activate different combinations of the one or more configured SRS resource sets as the coordinated TRP transmission direction for the terminal to coordinately transmit the PUSCH towards the plurality of TRP transmission directions.

In an implementation of the present disclosure, the network device may activate, through indication information, an SRS resource set as the coordinated TRP transmission direction for the terminal to coordinately transmit the PUSCH towards the plurality of TRP transmission directions. In the following, the indication information indicating the SRS resource set as the coordinated TRP transmission direction for the terminal to coordinately transmit the PUSCH towards the plurality of TRP transmission directions is referred to as first indication information.

FIG. 4 shows a flowchart of a method for determining an uplink coordinated TRP according to an embodiment of the present disclosure. The method for determining the uplink coordinated TRP may be executed alone or in combination with other embodiments of the present disclosure. As shown in FIG. 4, the method for determining the uplink coordinated TRP is performed by a network device and includes steps S31 and S32.

In the step S31, a plurality of SRS resource sets are configured through a higher layer signaling. Respective SRS resource sets of the plurality of SRS resource sets configured by the network device through the higher layer signaling are correspondingly associated with different terminal panels or different TRP transmission directions.

In the step S32, first indication information is sent, and the first indication information is configured to indicate part or all of the plurality of SRS resource sets. In embodiments of the present disclosure, the network device may activate, according to known information, such as a new measurement or reciprocity, part or all of the plurality of SRS resource sets for the terminal through the first indication information. A TRP transmission direction associated with part or all activated by the network device of the plurality of SRS resource sets is used as the coordinated TRP transmission direction for the terminal to coordinately transmit the PUSCH towards the plurality of TRP transmission directions.

In an example, the network device configures four SRS resource sets #1-#4. Respective SRS resource sets of the SRS resource sets #1-#4 are associated with different TRP transmission directions. For example, SRS resource set #1 is associated with TRP1 transmission direction, SRS resource set #2 is associated with TRP2 transmission direction, SRS resource set #3 is associated with TRP3 transmission direction, and SRS resource set #4 is associated with TRP4 transmission direction. If the first indication information indicates SRS resource set #1 and SRS resource set #3, it may be determined that the terminal transmits the PUSCH towards the TRP1 transmission direction and the TRP2 transmission direction.

In embodiments of the present disclosure, a default TRP transmission direction may also be set. The activation of part or all of the plurality of SRS resource sets may be through update information that indicates an update relative to the default TRP transmission direction to activate part or all of the plurality of SRS resource sets as the coordinated TRP transmission direction for the terminal to coordinately transmit the PUSCH towards the plurality of TRP transmission directions.

In an implementation of the present disclosure, the first indication information may be an activation command carried in a Medium Access Control (MAC)-Control Element (CE).

In embodiments of the present disclosure, when part or all of the plurality of SRS resource sets are activated through the MAC-CE, on the one hand, respective SRS resource sets may be activated in an independent indication manner, or on the other hand, respective SRS resource sets may also be activated in a joint indication manner.

For the independent indication manner, the first indication information includes a plurality pieces of indication information carried in a MAC-CE signaling, and each of the plurality pieces of indication information corresponds to one SRS resource set. For example, there are four SRS resource sets #1-#4 configured with the function of “codebook”, and SRS resource set #1 and SRS resource set #3 are used as the coordinated TRP transmission direction for the terminal to coordinately transmit the PUSCH towards the plurality of TRP transmission directions, then SRS resource set #1 and SRS resource set #3 among the four SRS resource sets #1-#4 are respectively activated to be used as the coordinated TRP transmission direction for the terminal to coordinately transmit the PUSCH towards the plurality of TRP transmission directions.

For the joint indication manner, the first indication information includes one piece of indication information carried in the MAC-CE signaling, and the one piece of indication information corresponds to the plurality of SRS resource sets. For example, an activation state of the SRS resource set is jointly indicated through the indication information preconfigured or predefined by the network. Based on the above example, the activation of SRS resource set #1 and SRS resource set #3 among SRS resource sets #1-#4 may be indicated, for example, by codepoint.

In another implementation of embodiments of the present disclosure, the network device may respectively configure SRS resources in the SRS resource set configuration defined by the current protocol and supporting a multi-TRP PUSCH coordinated transmission to be associated with a plurality of TRP transmission directions, for the terminal to perform the dynamical selection of coordinated TRP transmission direction.

The SRS resource set defined by the protocol and supporting the multi-TRP PUSCH coordinated transmission may be a SRS resource set configuration configured with two SRS resource sets that supports two TRPs.

FIG. 5 shows a flowchart of a method for determining an uplink coordinated TRP according to an embodiment of the present disclosure. The method for determining the uplink coordinated TRP may be executed alone or in combination with other embodiments of the present disclosure. As shown in FIG. 5, the method for determining the uplink coordinated TRP is performed by a network device and includes step S41.

In the step S41, an SRS resource set for coordinately transmitting a PUSCH towards a plurality of TRP transmission directions is configured, and each SRS resource configuration in the SRS resource set is associated with the plurality of TRP transmission directions.

In an example, the network device configures SRS resource set 1 and/or SRS resource set 2. SRS resource set 1 includes resource 1, resource 2 . . . resource n, and SRS resource set 2 includes resource 1, resource 2 . . . resource m, where m and n are positive integers and may be the same or different. In embodiments of the present disclosure, associated TRP transmission directions may be respectively configured for resource 1, resource 2, . . . and resource n included in SRS resource set 1. For example, resource 1 is associated with TRP1 transmission direction and TRP2 transmission direction, resource 2 is associated with TRP3 transmission direction and TRP4 transmission direction, . . . resource n is associated with TRPx transmission direction and TRPy transmission direction. An implementation of configuring resource 1, resource 2 . . . resource m included in SRS resource set 2 to be associated with a plurality of TRP transmission directions is similar.

One TRP transmission direction may include a plurality pieces of different spatial beam information, such as spatial relation info.

In embodiments of the present disclosure, each SRS resource in the SRS resource set may be associated with a plurality pieces of spatial relation info, or a spatial relation info set may be defined for each SRS resource in the SRS resource set, respectively corresponding to different panels or different TRP transmission directions.

In an implementation of embodiments of the present disclosure, for the codebook-based transmission, that is, in a case that the SRS resource set is a codebook transmission-based SRS resource set, each SRS resource in the codebook transmission-based SRS resource set is configured with a plurality of TRP transmission directions. That is, an SRS resource set with the function of “codebook” may be configured with a plurality of SRS resources, and each SRS resource is configured with a plurality of fixed beam directions, for example, spatial relation info.

In another implementation of embodiments of the present disclosure, for the non-codebook-based transmission, that is, in a case that the SRS resource set is a non-codebook transmission-based SRS resource set, each SRS resource in the non-codebook transmission-based SRS resource set is configured with a plurality of TRP transmission directions, or configured with a plurality of CSI-RSs associated with a plurality of corresponding TRPs.

That is, for the non-codebook-based transmission, an SRS resource set with the function of “non-codebook” may be configured with a plurality of SRS resources, and each SRS resource may be configured with a plurality of specific beam directions, for example, spatial relation info, or configured with a plurality of CSI-RSs associated with a specific TRP. However, it is not allowed to configure both the spatial relation info and the CSI-RS associated with the TRP.

In embodiments of the present disclosure, the network device may activate a TRP transmission direction among the plurality of TRP transmission directions associated with the SRS resource, as the coordinated TRP transmission direction for the terminal to coordinately transmit the PUSCH towards the plurality of TRP transmission directions.

In an implementation of the present disclosure, the network device may activate a TRP transmission direction through indication information, as the coordinated TRP transmission direction for the terminal to coordinately transmit the PUSCH towards the plurality of TRP transmission directions. In the following, the indication information indicating the TRP transmission direction as the coordinated TRP transmission direction for the terminal to coordinately transmit the PUSCH towards the plurality of TRP transmission directions is referred to as second indication information.

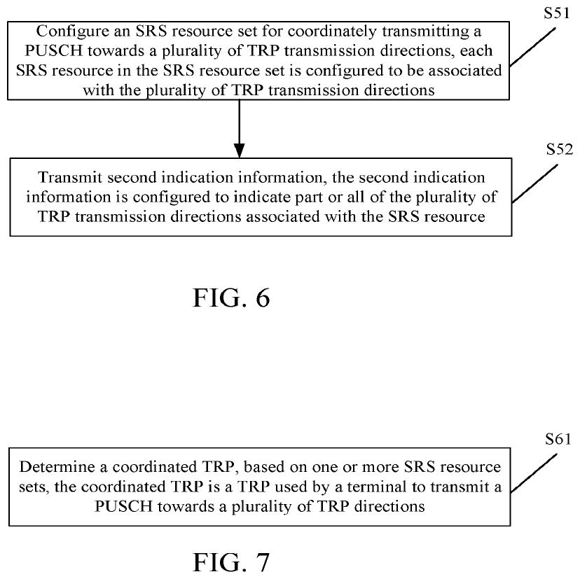

FIG. 6 shows a flowchart of a method for determining an uplink coordinated TRP according to an embodiment of the present disclosure. The method for determining the uplink coordinated TRP may be executed alone or in combination with other embodiments of the present disclosure. As shown in FIG. 6, the method for determining the uplink coordinated TRP is performed by a network device and includes steps S51 and S52.

In the step S51, an SRS resource set for coordinately transmitting a PUSCH towards a plurality of TRP transmission directions is configured, and each SRS resource configuration in the SRS resource set is associated with the plurality of TRP transmission directions.

In the step S52, second indication information is sent, and the second indication information is configured to indicate part or all of the plurality of TRP transmission directions associated with the SRS resource.

In embodiments of the present disclosure, part or all, indicated by the second indication information, of the plurality of TRP transmission directions associated with the SRS resource, may be used as the coordinated TRP transmission direction for the terminal to coordinately transmit the PUSCH towards the plurality of TRP transmission directions.

Based on the above example, in a case that resource 1 included in SRS resource set 1 is associated with TRP1 transmission direction and TRP2 transmission direction, resource 2 included in SRS resource set 1 is associated with TRP3 transmission direction and TRP4 transmission direction, . . . resource n included in SRS resource set 1 is associated with TRPx transmission direction and TRPy transmission direction, the second indication information may activate the TRP1 transmission direction, the TRP3 transmission direction, and the TRPx transmission direction. The terminal coordinately transmits the PUSCH towards the TRP1 transmission direction, the TRP3 transmission direction, and the TRPx transmission direction.

In embodiments of the present disclosure, according to known information, the network device may activate, through the second indication information, for the terminal part or all of the plurality of TRP transmission directions associated with the SRS resource, as the coordinated TRP transmission direction for the terminal to coordinately transmit the PUSCH towards the plurality of TRP transmission directions.

In an implementation of the present disclosure, the second indication information may be an activation command carried in the MAC-CE.

In embodiments of the present disclosure, when part or all of the plurality of TRP transmission directions associated with the SRS resource are activated through the MAC-CE, on the one hand, respective TRP transmission directions may be activated in an independent indication manner, or on the other hand, respective TRP transmission directions may also be activated in a joint indication manner.

For an implementation of independently indicating the respective TRP transmission directions, beam information corresponding to each SRS resource in each resource set is independently indicated. That is, the second indication information includes a plurality pieces of indication information carried in the MAC-CE signaling, and each of the plurality pieces of indication information corresponds to one TRP transmission direction.

For the joint indication of the respective TRP transmission directions, direction information of a plurality of resources in the resource set may be jointly indicated through the spatial relation info codepoint, or a resource direction information combination corresponding to different resource sets may be jointly indicated through the spatial relation info codepoint. That is, the second indication information includes one piece of indication information carried in the MAC-CE signaling, and the one piece of indication information corresponds to a plurality of TRP transmission directions.

In embodiments of the present disclosure, the above manner based on the configuration and activation by the network device realizes the implementation of configuring for the terminal the coordinated TRP transmission direction for the terminal to coordinately transmit the PUSCH towards the plurality of TRP transmission directions, which facilitates the terminal to dynamically select the coordinated TRP transmission direction.

In embodiments of the present disclosure, an implementation in which the terminal selects the coordinated TRP transmission direction for coordinately transmitting the PUSCH towards the plurality of TRP transmission directions will be described below.

In embodiments of the present disclosure, the one or more SRS resource sets may be configured by the network device, and the coordinated TRP transmission direction for coordinately transmitting the PUSCH towards the plurality of TRP transmission directions may be determined by the terminal. Alternatively, a plurality of TRP transmission directions associated with each SRS resource in the SRS resource set defined by the protocol may be configured by the network device, and the coordinated TRP transmission direction for coordinately transmitting the PUSCH towards the plurality of TRP transmission directions may be determined by the terminal.

When determining the coordinated TRP transmission direction, the terminal may determine, based on factors such as path loss/MPE, the coordinated TRP transmission direction that is ultimately used to coordinately transmit the PUSCH towards the plurality of TRP transmission directions.

In embodiments of the present disclosure, after determining the coordinated TRP transmission direction to be used, the terminal may report to the network device all or part of the determined coordinated TRP transmission directions to be used, to facilitate the network device to perform communication coordination configuration.

Further, in embodiments of the present disclosure, in a case that the terminal reports all or part of the coordinated TRP transmission directions to be used, the terminal may report update information that indicates an update relative to the default TRP transmission direction.

Based on the same concept, embodiments of the present disclosure further provide a method for determining an uplink coordinated TRP, which is performed by a terminal.

FIG. 7 shows a flowchart of a method for determining an uplink coordinated TRP according to an embodiment of the present disclosure. The method for determining the uplink coordinated TRP may be executed alone or in combination with other embodiments of the present disclosure. As shown in FIG. 7, the method for determining the uplink coordinated TRP is performed by a terminal and includes step S61.

In the step S61, a coordinated TRP is determined based on one or more SRS resource sets, and the coordinated TRP is a TRP used by the terminal to coordinately transmit a PUSCH towards a plurality of TRP transmission directions.

In embodiments of the present disclosure, the SRS resource set used by the terminal to determine the coordinated TRP transmission direction for coordinately transmitting the PUSCH towards the plurality of TRP transmission directions may be, on the one hand, a plurality of SRS resource sets configured by a network device through a higher layer signaling, and respective SRS resource sets of the plurality of SRS resource sets are correspondingly associated with different terminal panels or different TRP transmission directions, and on the other hand, may also be an SRS resource set that configures the coordinated transmission of the PUSCH towards the plurality of TRP transmission directions, and each SRS resource in the SRS resource set is configured to be associated with a plurality of TRP transmission directions.

In a case that based on a plurality of SRS resource sets configured by the network device that are associated with different terminal panels or different TRP transmission directions, the terminal determines the coordinated TRP transmission direction for coordinately transmitting the PUSCH towards the plurality of TRP transmission directions, it may be based on an activation command (first indication information), and part or all of the plurality of SRS resource sets serve as the coordinated TRP transmission direction for the terminal to coordinately transmit the PUSCH towards a plurality of TRP transmission directions.

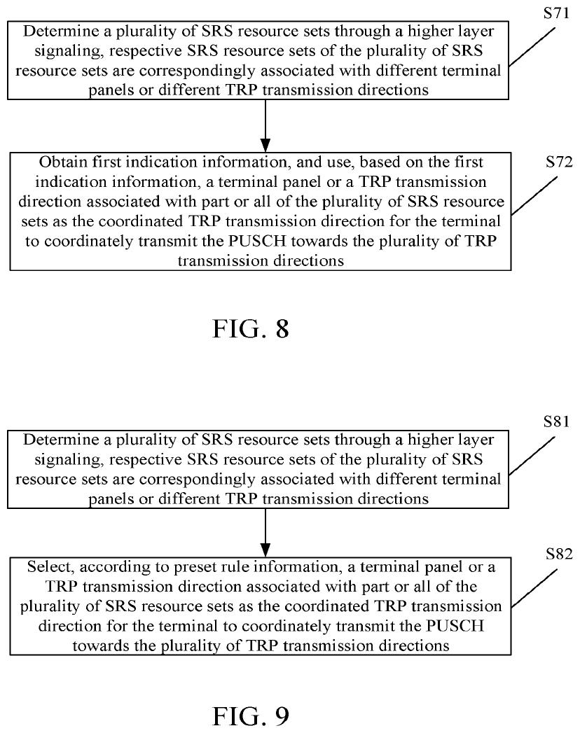

FIG. 8 shows a flowchart of a method for determining an uplink coordinated TRP according to an embodiment of the present disclosure. The method for determining the uplink coordinated TRP may be executed alone or in combination with other embodiments of the present disclosure. As shown in FIG. 8, the method for determining the uplink coordinated TRP is performed by a terminal and includes steps S71 and S72.

In the step S71, a plurality of SRS resource sets are determined through a higher layer signaling, and respective SRS resource sets of the plurality of SRS resource sets are correspondingly associated with different terminal panels or different TRP transmission directions.

In the step S72, first indication information is obtained, and based on the first indication information, a terminal panel or a TRP transmission direction associated with part or all of the plurality of SRS resource sets is used as the coordinated TRP transmission direction for the terminal to coordinately transmit the PUSCH towards the plurality of TRP transmission directions.

In an implementation of embodiments of the present disclosure, the higher layer signaling used by the terminal to determine the plurality of SRS resource sets may be the RRC signaling, and the first indication information may be an activation command carried in a MAC-CE signaling. That is, the terminal may use different combinations of SRS resource sets as the coordinated TRP transmission direction for multi-TRP transmission PUSCH in the RRC+MAC-CE manner.

In an implementation of the present disclosure, in a case that the first indication information is the activation command carried in the MAC-CE signaling, on the one hand, the first indication information may, on the one hand, include a plurality pieces of indication information carried in the MAC-CE signaling, and each of the plurality pieces of indication information corresponds to one SRS resource set, that is, the terminal determines the coordinated TRP transmission direction through the plurality pieces of independently indicated indication information. Alternatively, on the other hand, the first indication information includes one piece of indication information carried in the MAC-CE signaling, and the one piece of indication information corresponds to a plurality of SRS resource sets, that is, the terminal determines the coordinated TRP transmission direction through the plurality pieces of jointly indicated indication information.

In embodiments of the present disclosure, the terminal may also determine, based on preset rule information (path loss/MPE and other factors), the terminal panel or the TRP transmission direction associated with part or all of the plurality of SRS resource sets configured through the higher layer signaling, as the coordinated TRP transmission direction for the terminal to coordinately transmit the PUSCH towards the plurality of TRP transmission directions.

FIG. 9 shows a flowchart of a method for determining an uplink coordinated TRP according to an embodiment of the present disclosure. The method for determining the uplink coordinated TRP may be executed alone or in combination with other embodiments of the present disclosure. As shown in FIG. 9, the method for determining the uplink coordinated TRP is performed by a terminal and includes steps S81 and S82.

In the step S81, a plurality of SRS resource sets are determined through a higher layer signaling, and respective SRS resource sets of the plurality of SRS resource sets are correspondingly associated with different terminal panels or different TRP transmission directions.

In the step S82, according to preset rule information, a terminal panel or a TRP transmission direction associated with part or all of the plurality of SRS resource sets is selected as the coordinated TRP transmission direction for the terminal to coordinately transmit the PUSCH towards the plurality of TRP transmission directions.

In embodiments of the present disclosure, according to the plurality of SRS resource sets associated with different terminal panels or different TRP transmission directions and configured by the network device, the terminal may select, according to the preset rule information related to a factor such as path loss/MPE, the terminal panel or the TRP transmission direction associated with part or all of the plurality of SRS resource sets, as the coordinated TRP transmission direction for the terminal to coordinately transmit the PUSCH towards the plurality of TRP transmission directions.

It can be understood that in an implementation, the plurality of SRS resource sets determined by the terminal through the higher layer signaling may be, on the one hand, codebook transmission-based SRS resource sets, and each SRS resource in the codebook transmission-based SRS resource set is configured with corresponding TRP transmission direction indication information, that is, each SRS resource in the codebook transmission-based SRS resource set corresponds to a different terminal antenna panel or a different TRP transmission direction. On the other hand, the plurality of SRS resource sets determined by the terminal through the higher layer signaling may be a plurality of non-codebook transmission-based SRS resource sets, and each SRS resource in the non-codebook transmission-based SRS resource set is configured with corresponding TRP transmission direction indication information, or is configured with the CSI-RS associated with the corresponding TRP.

In another implementation of embodiments of the present disclosure, the terminal determines, based on the plurality of TRP transmission directions associated with each SRS resource in the SRS resource set for coordinately transmitting the PUSCH towards the plurality of TRP transmission directions, the coordinated TRP transmission direction for the terminal to coordinately transmit the PUSCH towards the plurality of TRP transmission directions.

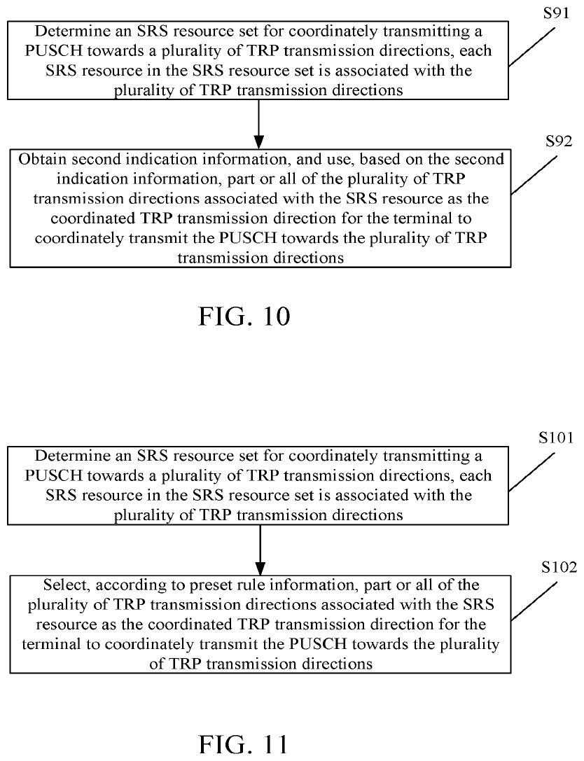

FIG. 10 shows a flowchart of a method for determining an uplink coordinated TRP according to an embodiment of the present disclosure. The method for determining the uplink coordinated TRP may be executed alone or in combination with other embodiments of the present disclosure. As shown in FIG. 10, the method for determining the uplink coordinated TRP is performed by a terminal and includes steps S91 and S92.

In the step S91, an SRS resource set for coordinately transmitting a PUSCH towards a plurality of TRP transmission directions is determined, and each SRS resource in the SRS resource set is associated with the plurality of TRP transmission directions.

In the step S92, second indication information is obtained, and based on the second indication information, part or all of the plurality of TRP transmission directions associated with the SRS resource are used as the coordinated TRP transmission direction for the terminal to coordinately transmit the PUSCH towards the plurality of TRP transmission directions.

In embodiments of the present disclosure, the second indication information may be an activation command carried in the MAC-CE.

In an implementation of the present disclosure, the second indication information includes a plurality pieces of indication information carried in the MAC-CE signaling, and each of the plurality pieces of indication information corresponds to one TRP transmission direction. That is, the terminal determines, based on respective TRP transmission directions independently indicated by the network device, the coordinated TRP transmission direction for the terminal to coordinately transmit the PUSCH towards the plurality of TRP transmission directions. Alternatively, on the other hand, the second indication information includes one piece of indication information carried in the MAC-CE signaling, and the one piece of indication information corresponds to the plurality of TRP transmission directions.

That is, the terminal determines, through indication information that the network device activates respective TRP transmission directions in a joint indication manner, the coordinated TRP transmission direction for the terminal to coordinately transmit the PUSCH towards the plurality of TRP transmission directions.

In embodiments of the present disclosure, the terminal may also select, according to the preset rule information (path loss/MPE and other factors), part or all of the plurality of TRP transmission directions associated with the SRS resource as the coordinated TRP transmission direction for the terminal to coordinately transmit the PUSCH towards the plurality of TRP transmission directions.

FIG. 11 shows a flowchart of a method for determining an uplink coordinated TRP according to an embodiment of the present disclosure. The method for determining the uplink coordinated TRP may be executed alone or in combination with other embodiments of the present disclosure. As shown in FIG. 11, the method for determining the uplink coordinated TRP is performed by a terminal and includes steps S101 and S102.

In the step S101, an SRS resource set for coordinately transmitting a PUSCH towards a plurality of TRP transmission directions is determined, and each SRS resource in the SRS resource set is associated with the plurality of TRP transmission directions.

In the step S102, according to preset rule information, part or all of the plurality of TRP transmission directions associated with the SRS resource are selected as a coordinated TRP transmission direction for the terminal to coordinately transmit a PUSCH towards a plurality of TRP transmission directions.

In embodiments of the present disclosure, the terminal may select, based on the preset rule information related to factors such as path loss/MPE, part or all of the plurality of TRP transmission directions associated with the SRS resource, as the coordinated TRP transmission direction for the terminal to coordinately transmit the PUSCH towards the plurality of TRP transmission directions.

Further, in embodiments of the present disclosure, the SRS resource set for coordinately transmitting the PUSCH towards the plurality of TRP transmission directions may be a codebook transmission-based SRS resource set, and each SRS resource in the codebook transmission-based SRS resource set is configured with a plurality pieces of corresponding TRP transmission direction indication information. In embodiments of the present disclosure, the SRS resource set for coordinately transmitting the PUSCH towards the plurality of TRP transmission directions may also be a non-codebook transmission-based SRS resource set. Each SRS resource in the non-codebook transmission-based SRS resource set is configured with a plurality pieces of corresponding TRP transmission direction indication information, or configured with a plurality of CSI-RSs associated with the corresponding TRP.

In embodiments of the present disclosure, after determining the coordinated TRP transmission direction to be used, the terminal may report to the network device all or part of the determined coordinated TRP transmission directions to be used, to facilitate the network device to perform communication coordination configuration.

The method for determining the uplink coordinated TRP provided by embodiments of the present disclosure realizes the configuration and update of the coordinated TRP under the multi-TRP configuration, which is used to adapt to a change in a downlink TRP or a change in the coordinated TRP caused by other reasons such as terminal mobility, MPC, etc., thereby better supporting a change in a transmission scenario and improving transmission reliability.

It can be understood that an implementation process for the terminal to perform the method for determining the uplink coordinated TRP is similar to an implementation process for the network device to perform the method for determining the uplink coordinated TRP in the above embodiments. For details, reference may be made to the relevant description of the above embodiments, which will not be described in detail here.

It can be further understood that the method for determining the uplink coordinated TRP provided by embodiments of the present disclosure may be applicable to a scenario in which the terminal and the network device interact to perform the method for determining the uplink coordinated TRP. For functions implemented by the terminal and the network device involved in a specific implementation process, reference may be made to the relevant descriptions involved in the above embodiments, which will not be described in detail here.

It should be noted that those skilled in the art can understand that various implementations/embodiments involved in the foregoing embodiments of the present disclosure may be used in conjunction with the foregoing embodiments, or may be used independently. Whether used alone or in conjunction with the foregoing embodiments, implementation principles are similar. In embodiments of the present disclosure, some of the embodiments are described by means of implementations that are used together. Please note that those skilled in the art can understand that such illustrative description is not intended to limit embodiments of the present disclosure.

Based on the same concept, embodiments of the present disclosure further provide an apparatus for determining an uplink coordinated TRP.

It can be understood that, in order to implement the above-mentioned functions, the apparatus for determining the uplink coordinated TRP provided by embodiments of the present disclosure includes corresponding hardware structures and/or software modules for executing respective functions. In combination with units and algorithm steps of various examples disclosed in embodiments of the present disclosure, embodiments of the present disclosure may be implemented by in a form of hardware or a combination of the hardware and computer software. Whether a certain function is implemented in the fashion of hardware or in the fashion that the computer software drives the hardware depends on a particular application and design constraints of the technical solution. A person skilled in the art may implement the described functions with different methods for each particular application, but such an implementation shall not be regarded as going beyond the scope of the technical solution according to embodiments of the present disclosure.

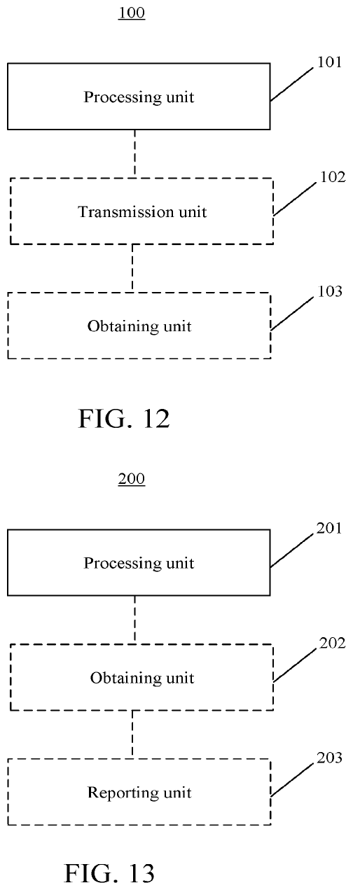

FIG. 12 shows a block diagram of an apparatus for determining an uplink coordinated TRP according to an embodiment of the present disclosure. Referring to FIG. 12, the apparatus 100 for determining the uplink coordinated TRP includes a processing unit 101.

The processing unit 101 is configured to configure and determine, based on one or more SRS resource sets, one or more TRP transmission directions. The one or more TRP transmission directions are configured to determine a coordinated TRP, and the coordinated TRP is a TRP used by a terminal to coordinately transmit a PUSCH towards a plurality of TRP transmission directions.

In an implementation of the present disclosure, the processing unit 101 configures a plurality of SRS resource sets through a higher layer signaling, and respective SRS resource sets of the plurality of SRS resource sets are correspondingly associated with different terminal panels or different TRP transmission directions.

In an implementation of the present disclosure, the plurality of SRS resource sets include a codebook transmission-based SRS resource set; and each SRS resource in the codebook transmission-based SRS resource set is configured with corresponding TRP transmission direction indication information.

In an implementation of the present disclosure, the plurality of SRS resource sets include a non-codebook transmission-based SRS resource set; and each SRS resource in the non-codebook transmission-based SRS resource set is configured with corresponding TRP transmission direction indication information or a CSI-RS associated with a corresponding TRP.

In an implementation of the present disclosure, the apparatus 100 for determining the uplink coordinated TRP further includes a transmission unit 102, configured to transmit first indication information, and the first indication information is configured to indicate part or all of the plurality of SRS resource sets.

In an implementation of the present disclosure, the first indication information includes a plurality pieces of indication information carried in a MAC-CE signaling, and each of the plurality pieces of indication information corresponds to one SRS resource set; or the first indication information includes one piece of indication information carried in the MAC-CE signaling, and the one piece of indication information corresponds to the plurality of SRS resource sets.

In an implementation of the present disclosure, the processing unit 101 configures an SRS resource set for coordinately transmitting the PUSCH towards the plurality of TRP transmission directions, and each SRS resource in the SRS resource set is configured to be associated with the plurality of TRP transmission directions.

In an implementation of the present disclosure, the SRS resource set is a codebook transmission-based SRS resource set; and each SRS resource in the codebook transmission-based SRS resource set is configured with the plurality of TRP transmission directions.

In an implementation of the present disclosure, the SRS resource set is a non-codebook transmission-based SRS resource set; and
each SRS resource in the non-codebook transmission-based SRS resource set is configured with the plurality of TRP transmission directions, or a plurality of CSI-RSs associated with a plurality of corresponding TRPs.

In an implementation of the present disclosure, the apparatus 100 for determining the uplink coordinated TRP further includes a transmission unit 102, configured to transmit second indication information, and the second indication information is configured to indicate part or all of the plurality of TRP transmission directions associated with the SRS resource, as a coordinated TRP transmission direction for the terminal to coordinately transmit the PUSCH towards the plurality of TRP transmission directions.

In an implementation of the present disclosure, the second indication information includes a plurality pieces of indication information carried in a MAC-CE signaling, and each of the plurality pieces of indication information corresponds to one TRP transmission direction; or the second indication information includes one piece of indication information carried in the MAC-CE signaling, and the one piece of indication information corresponds to the plurality of TRP transmission directions.

In an implementation of the present disclosure, the apparatus 100 for determining the uplink coordinated TRP further includes an obtaining unit 103, configured to obtain all or part of coordinated TRP transmission directions reported by the terminal.

FIG. 13 shows a block diagram of an apparatus for determining an uplink coordinated TRP according to an embodiment of the present disclosure. Referring to FIG. 13, the apparatus 200 for determining the uplink coordinated TRP includes a processing unit 201.

The processing unit 201 is configured to determine a coordinated TRP based on one or more SRS resource sets, and the coordinated TRP is a TRP used by the terminal to coordinately transmit a PUSCH towards a plurality of TRP transmission directions.

In an implementation of the present disclosure, the processing unit 201 determines a plurality of SRS resource sets through a higher layer signaling, and respective SRS resource sets of the plurality of SRS resource sets are correspondingly associated with different terminal panels or different TRP transmission directions.

The apparatus 200 for determining the uplink coordinated TRP further includes an obtaining unit 202, configured to obtain first indication information. The processing unit 201 uses, based on the first indication information, a terminal panel or a TRP transmission direction associated with part or all of the plurality of SRS resource sets as the coordinated TRP transmission direction for the terminal to coordinately transmit the PUSCH towards the plurality of TRP transmission directions.

In an implementation of the present disclosure, the first indication information includes a plurality pieces of indication information carried in a MAC-CE signaling, and each of the plurality pieces of indication information corresponds to one SRS resource set; or the first indication information includes one piece of indication information carried in the MAC-CE signaling, and the one piece of indication information corresponds to the plurality of SRS resource sets.

In an implementation of the present disclosure, the processing unit determines a plurality of SRS resource sets, and respective SRS resource sets of the plurality of SRS resource sets are correspondingly associated with different terminal panels or different TRP transmission directions; and selects, according to preset rule information, a terminal panel or a TRP transmission direction associated with part or all of the plurality of SRS resource sets as the coordinated TRP transmission direction for the terminal to coordinately transmit the PUSCH towards the plurality of TRP transmission directions.

In an implementation of the present disclosure, the plurality of SRS resource sets include a codebook transmission-based SRS resource set; and each SRS resource in the codebook transmission-based SRS resource set is configured with corresponding TRP transmission direction indication information.

In an implementation of the present disclosure, the plurality of SRS resource sets include a non-codebook transmission-based SRS resource set; and each SRS resource in the non-codebook transmission-based SRS resource set is configured with corresponding TRP transmission direction indication information or a CSI-RS associated with a corresponding TRP.

In an implementation of the present disclosure, the processing unit 201 determines an SRS resource set for coordinately transmitting the PUSCH towards the plurality of TRP transmission directions, and each SRS resource in the SRS resource set is associated with the plurality of TRP transmission directions.

The apparatus 200 for determining the uplink coordinated TRP further includes an obtaining unit 202, configured to obtain second indication information. The processing unit 201 uses, based on the second indication information, part or all of the plurality of TRP transmission directions associated with the SRS resource as the coordinated TRP transmission direction for the terminal to coordinately transmit the PUSCH towards the plurality of TRP transmission directions.

In an implementation of the present disclosure, the second indication information includes a plurality pieces of indication information carried in a MAC-CE signaling, and each of the plurality pieces of indication information corresponds to one TRP transmission direction; or the second indication information includes one piece of indication information carried in the MAC-CE signaling, and the one piece of indication information corresponds to the plurality of TRP transmission directions.

In an implementation of the present disclosure, the processing unit 201 determines an SRS resource set for coordinately transmitting the PUSCH towards the plurality of TRP transmission directions, and each SRS resource in the SRS resource set is associated with the plurality of TRP transmission directions; and selects, according to preset rule information, part or all of the plurality of TRP transmission directions associated with the SRS resource as the coordinated TRP transmission direction for the terminal to coordinately transmit the PUSCH towards the plurality of TRP transmission directions.

In an implementation of the present disclosure, the SRS resource set is a codebook transmission-based SRS resource set; and each SRS resource in the codebook transmission-based SRS resource set is configured with a plurality pieces of corresponding TRP transmission direction indication information.

In an implementation of the present disclosure, the SRS resource set is a non-codebook transmission-based SRS resource set; and each SRS resource in the non-codebook transmission-based SRS resource set is configured with a plurality pieces of corresponding TRP transmission direction indication information, or a plurality of CSI-RSs associated with a corresponding TRP.

In an implementation of the present disclosure, the apparatus 200 for determining the uplink coordinated TRP further includes a reporting unit 203, configured to report all or part of the determined coordinated TRP transmission directions to a network device.

Regarding the apparatus in the foregoing embodiments, a specific manner in which each module executes operations has been described in detail in embodiments related to the method, and will not be described in detail here.

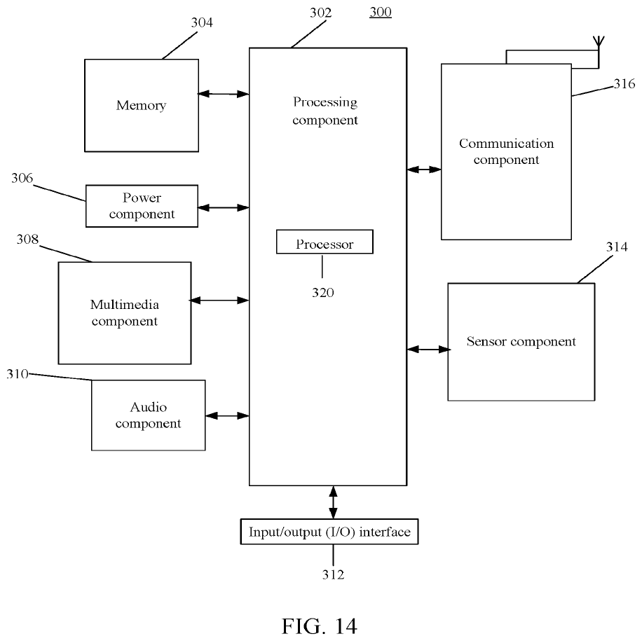

FIG. 14 shows a block diagram of a device for determining an uplink coordinated TRP according to an embodiment of the present disclosure. For example, the device 300 may be a mobile phone, a computer, a digital broadcast terminal, a messaging apparatus, a gaming console, a tablet, a medical apparatus, exercise equipment, a personal digital assistant, etc.

Referring to FIG. 14, the device 300 may include one or more of the following components: a processing component 302, a memory 304, a power component 306, a multimedia component 308, an audio component 310, an input/output (I/O) interface 312, a sensor component 314, and a communication component 316.

The processing component 302 typically controls overall operations of the device 300, such as the operations associated with display, telephone calls, data communications, camera operations, and recording operations. The processing component 302 may include one or more processors 320 to execute instructions to perform all or part of the steps in the above described methods. Moreover, the processing component 302 may include one or more modules which facilitate the interaction between the processing component 302 and other components. For instance, the processing component 302 may include a multimedia module to facilitate the interaction between the multimedia component 308 and the processing component 302.

The memory 304 is configured to store various types of data to support the operation of the device 300. Examples of such data include instructions for any applications or methods operated on the device 300, contact data, phonebook data, messages, pictures, video, etc. The memory 304 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 306 provides power to various components of the device 300. The power component 306 may include a power management system, one or more power sources, and any other components associated with the generation, management, and distribution of power in the device 300.

The multimedia component 308 includes a screen providing an output interface between the device 300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 308 includes a front camera and/or a rear camera. The front camera and the rear camera may receive an external multimedia datum while the device 300 is in an operation mode, such as a photographing mode or a video mode. Each of the front camera and the rear camera may be a fixed optical lens system or have focus and optical zoom capability.

The audio component 310 is configured to output and/or input audio signals. For example, the audio component 310 includes a microphone (MIC) configured to receive an external audio signal when the device 300 is in an operation mode, such as a call mode, a recording mode, and a voice recognition mode. The received audio signal may be further stored in the memory 304 or transmitted via the communication component 316. In some embodiments, the audio component 310 further includes a speaker to output audio signals.

The I/O interface 312 provides an interface between the processing component 302 and peripheral interface modules, such as a keyboard, a click wheel, buttons, and the like. The buttons may include, but are not limited to, a home button, a volume button, a starting button, and a locking button.

The sensor component 314 includes one or more sensors to provide state assessments of various aspects of the device 300. For instance, the sensor component 314 may detect an open/closed state of the device 300, relative positioning of components, e.g., the display and the keypad, of the device 300, a change in position of the device 300 or a component of the device 300, a presence or absence of user contact with the device 300, an orientation or an acceleration/deceleration of the device 300, and a change in temperature of the device 300. The sensor component 314 may include a proximity sensor configured to detect the presence of nearby objects without any physical contact. The sensor component 314 may also include a light sensor, such as a CMOS or CCD image sensor, for use in imaging applications. In some embodiments, the sensor component 314 may also include an accelerometer sensor, a gyroscope sensor, a magnetic sensor, a pressure sensor, or a temperature sensor.

The communication component 316 is configured to facilitate communication, wired or wirelessly, between the device 300 and other devices. The device 300 may access a wireless network based on any communication standard, such as WiFi, 2G, or 3G, or a combination thereof. In an embodiment, the communication component 316 receives a broadcast signal or broadcast associated information from an external broadcast management system via a broadcast channel. In an embodiment, the communication component 316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the device 300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In an embodiment, there is further provided a non-transitory computer readable storage medium including instructions, such as the memory 304 including instructions, the above instructions may be performed by the processor 320 in the device 300 for performing the above-described methods. For example, the non-transitory computer-readable storage medium may be a ROM, a Random Access Memory (RAM), a CD-ROM, a magnetic tape, a floppy disc, an optical data storage device, and the like.

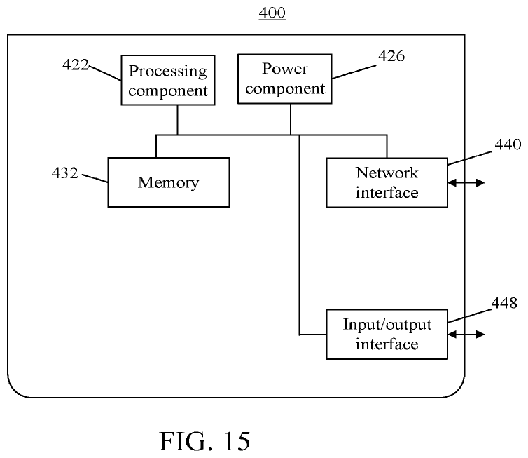

FIG. 15 shows a block diagram of a device for determining an uplink coordinated TRP according to an embodiment of the present disclosure. For example, the device 400 may be provided as a network device. Referring to FIG. 15, the device 400 includes a processing component 422, which further includes one or more processors and a memory resource represented by a memory 432 for storing instructions executable by the processing component 422, such as an application program. The application program stored in the memory 432 may include one or more modules, each corresponding to a set of instructions. In addition, the processing component 422 is configured to execute the instructions to execute the aforementioned method.

The device 400 may also include: a power component 426 configured to perform power management of the device 400, a wired or wireless network interface 440 configured to connect the device 400 to the network, and an input/output (I/O) interface 448. The device 400 may operate an operating system stored in the memory 432, such as Windows Server™, Mac OS X™, Unix™, Linux™, FreeBSD™, or the like.

In an embodiment, there is further provided a non-transitory computer readable storage medium including instructions, such as the memory 432 including instructions, the above instructions may be performed by the processing component 422 in the device 400 for performing the above-described methods. For example, the non-transitory computer-readable storage medium may be a ROM, a Random Access Memory (RAM), a CD-ROM, a magnetic tape, a floppy disc, an optical data storage device, and the like.

The present disclosure provides a method and apparatus for determining an uplink coordinated TRP, and a non-transitory storage medium.

According to a first aspect of embodiments of the present disclosure, there is provided a method for determining an uplink coordinated TRP, which is performed by a network device. The method includes:
configuring and determining, based on one or more SRS resource sets, one or more TRP transmission directions, wherein the one or more TRP transmission directions are configured to determine a coordinated TRP, and the coordinated TRP is a TRP used by a terminal to coordinately transmit a PUSCH towards a plurality of TRP transmission directions.

In an implementation of the present disclosure, the configuring and determining, based on the one or more SRS resource sets, the one or more TRP transmission directions includes configuring a plurality of SRS resource sets through a higher layer signaling, wherein respective SRS resource sets of the plurality of SRS resource sets are correspondingly associated with different terminal panels or different TRP transmission directions.

In an implementation of the present disclosure, the plurality of SRS resource sets include a codebook transmission-based SRS resource set, and each SRS resource in the codebook transmission-based SRS resource set is configured with corresponding TRP transmission direction indication information.

In an implementation of the present disclosure, the plurality of SRS resource sets include a non-codebook transmission-based SRS resource set, and each SRS resource in the non-codebook transmission-based SRS resource set is configured with corresponding TRP transmission direction indication information or a CSI-RS associated with a corresponding TRP.

In an implementation of the present disclosure, the method for determining the uplink coordinated TRP further includes: transmitting first indication information, wherein the first indication information is configured to indicate part or all of the plurality of SRS resource sets.

In an implementation of the present disclosure, the first indication information includes a plurality pieces of indication information carried in a MAC-CE signaling, and each of the plurality pieces of indication information corresponds to one SRS resource set; or the first indication information includes one piece of indication information carried in the MAC-CE signaling, and the one piece of indication information corresponds to the plurality of SRS resource sets.

In an implementation of the present disclosure, the configuring and determining, based on the one or more SRS resource sets, the one or more TRP transmission directions includes configuring an SRS resource set for coordinately transmitting the PUSCH towards the plurality of TRP transmission directions; wherein each SRS resource in the SRS resource set is configured to be associated with the plurality of TRP transmission directions.

In an implementation of the present disclosure, the SRS resource set is a codebook transmission-based SRS resource set; and each SRS resource in the codebook transmission-based SRS resource set is configured with the plurality of TRP transmission directions.

In an implementation of the present disclosure, the SRS resource set is a non-codebook transmission-based SRS resource set, and each SRS resource in the non-codebook transmission-based SRS resource set is configured with the plurality of TRP transmission directions, or a plurality of CSI-RSs associated with a plurality of corresponding TRPs.

In an implementation of the present disclosure, the method for determining the uplink coordinated TRP further includes transmitting second indication information, wherein the second indication information is configured to indicate part or all of the plurality of TRP transmission directions associated with the SRS resource, as a coordinated TRP transmission direction for the terminal to coordinately transmit the PUSCH towards the plurality of TRP transmission directions.

In an implementation of the present disclosure, the second indication information includes a plurality pieces of indication information carried in a MAC-CE signaling, and each of the plurality pieces of indication information corresponds to one TRP transmission direction, or the second indication information includes one piece of indication information carried in the MAC-CE signaling, and the one piece of indication information corresponds to the plurality of TRP transmission directions.

In an implementation of the present disclosure, the method for determining the uplink coordinated TRP further includes: obtaining all or part of coordinated TRP transmission directions reported by the terminal.

According to a second aspect of embodiments of the present disclosure, there is provided a method for determining an uplink coordinated TRP, which is performed by a terminal. The method includes: determining a coordinated TRP based on one or more SRS resource sets, wherein the coordinated TRP is a TRP used by the terminal to coordinately transmit a PUSCH towards a plurality of TRP transmission directions.

In an implementation of the present disclosure, the determining, based on the one or more SRS resource sets, the coordinated TRP transmission direction for coordinately transmitting the PUSCH towards the plurality of TRP transmission directions includes:
determining a plurality of SRS resource sets through a higher layer signaling, wherein respective SRS resource sets of the plurality of SRS resource sets are correspondingly associated with different terminal panels or different TRP transmission directions; and obtaining first indication information, and using, based on the first indication information, a terminal panel or a TRP transmission direction associated with part or all of the plurality of SRS resource sets as the coordinated TRP transmission direction for the terminal to coordinately transmit the PUSCH towards the plurality of TRP transmission directions.

In an implementation of the present disclosure, the first indication information includes a plurality pieces of indication information carried in a MAC-CE signaling, and each of the plurality pieces of indication information corresponds to one SRS resource set; or the first indication information includes one piece of indication information carried in the MAC-CE signaling, and the one piece of indication information corresponds to the plurality of SRS resource sets.

In an implementation of the present disclosure, the determining, based on the one or more SRS resource sets, the coordinated TRP transmission direction for coordinately transmitting the PUSCH towards the plurality of TRP transmission directions includes determining a plurality of SRS resource sets, wherein respective SRS resource sets of the plurality of SRS resource sets are correspondingly associated with different terminal panels or different TRP transmission directions; and selecting, according to preset rule information, a terminal panel or a TRP transmission direction associated with part or all of the plurality of SRS resource sets as the coordinated TRP transmission direction for the terminal to coordinately transmit the PUSCH towards the plurality of TRP transmission directions.

In an implementation of the present disclosure, the plurality of SRS resource sets include a codebook transmission-based SRS resource set, and each SRS resource in the codebook transmission-based SRS resource set is configured with corresponding TRP transmission direction indication information.

In an implementation of the present disclosure, the plurality of SRS resource sets include a non-codebook transmission-based SRS resource set, and each SRS resource in the non-codebook transmission-based SRS resource set is configured with corresponding TRP transmission direction indication information or a CSI-RS associated with a corresponding TRP.

In an implementation of the present disclosure, the determining, based on the one or more SRS resource sets, the coordinated TRP transmission direction for coordinately transmitting the PUSCH towards the plurality of TRP transmission directions includes determining an SRS resource set for coordinately transmitting the PUSCH towards the plurality of TRP transmission directions, wherein each SRS resource in the SRS resource set is associated with the plurality of TRP transmission directions, and obtaining second indication information, and using, based on the second indication information, part or all of the plurality of TRP transmission directions associated with the SRS resource as the coordinated TRP transmission direction for the terminal to coordinately transmit the PUSCH towards the plurality of TRP transmission directions.

In an implementation of the present disclosure, the second indication information includes a plurality pieces of indication information carried in a MAC-CE signaling, and each of the plurality pieces of indication information corresponds to one TRP transmission direction; or the second indication information includes one piece of indication information carried in the MAC-CE signaling, and the one piece of indication information corresponds to the plurality of TRP transmission directions.

In an implementation of the present disclosure, the determining, based on the one or more SRS resource sets, the coordinated TRP transmission direction for coordinately transmitting the PUSCH towards the plurality of TRP transmission directions includes determining an SRS resource set for coordinately transmitting the PUSCH towards the plurality of TRP transmission directions, wherein each SRS resource in the SRS resource set is associated with the plurality of TRP transmission directions, and selecting, according to preset rule information, part or all of the plurality of TRP transmission directions associated with the SRS resource as the coordinated TRP transmission direction for the terminal to coordinately transmit the PUSCH towards the plurality of TRP transmission directions.

In an implementation of the present disclosure, the SRS resource set is a codebook transmission-based SRS resource set, and each SRS resource in the codebook transmission-based SRS resource set is configured with a plurality pieces of corresponding TRP transmission direction indication information.

In an implementation of the present disclosure, the SRS resource set is a non-codebook transmission-based SRS resource set, and each SRS resource in the non-codebook transmission-based SRS resource set is configured with a plurality pieces of corresponding TRP transmission direction indication information, or a plurality of CSI-RSs associated with a corresponding TRP.

In an implementation of the present disclosure, the method for determining the uplink coordinated TRP further includes reporting all or part of the determined coordinated TRP transmission directions to a network device.

According to a third aspect of embodiments of the present disclosure, there is provided an apparatus for determining an uplink coordinated TRP, including a processing unit, configured to configure and determine, based on one or more SRS resource sets, one or more TRP transmission directions. The one or more TRP transmission directions are configured to determine a coordinated TRP, and the coordinated TRP is a TRP used by a terminal to coordinately transmit a PUSCH towards a plurality of TRP transmission directions.

In an implementation of the present disclosure, the processing unit configures a plurality of SRS resource sets through a higher layer signaling; wherein respective SRS resource sets of the plurality of SRS resource sets are correspondingly associated with different terminal panels or different TRP transmission directions.

In an implementation of the present disclosure, the plurality of SRS resource sets include a codebook transmission-based SRS resource set, and each SRS resource in the codebook transmission-based SRS resource set is configured with corresponding TRP transmission direction indication information.

In an implementation of the present disclosure, the plurality of SRS resource sets include a non-codebook transmission-based SRS resource set, and each SRS resource in the non-codebook transmission-based SRS resource set is configured with corresponding TRP transmission direction indication information or a CSI-RS associated with a corresponding TRP.

In an implementation of the present disclosure, the apparatus for determining the uplink coordinated TRP further includes a transmission unit, configured to transmit first indication information, wherein the first indication information is configured to indicate part or all of the plurality of SRS resource sets.

In an implementation of the present disclosure, the first indication information includes a plurality pieces of indication information carried in a MAC-CE signaling, and each of the plurality pieces of indication information corresponds to one SRS resource set; or the first indication information includes one piece of indication information carried in the MAC-CE signaling, and the one piece of indication information corresponds to the plurality of SRS resource sets.

In an implementation of the present disclosure, the processing unit configures an SRS resource set for coordinately transmitting the PUSCH towards the plurality of TRP transmission directions; wherein each SRS resource in the SRS resource set is configured to be associated with the plurality of TRP transmission directions.

In an implementation of the present disclosure, the SRS resource set is a codebook transmission-based SRS resource set; and each SRS resource in the codebook transmission-based SRS resource set is configured with the plurality of TRP transmission directions.

In an implementation of the present disclosure, the SRS resource set is a non-codebook transmission-based SRS resource set, and each SRS resource in the non-codebook transmission-based SRS resource set is configured with the plurality of TRP transmission directions, or a plurality of CSI-RSs associated with a plurality of corresponding TRPs.

In an implementation of the present disclosure, the apparatus for determining the uplink coordinated TRP further includes a transmission unit, configured to transmit second indication information, wherein the second indication information is configured to indicate part or all of the plurality of TRP transmission directions associated with the SRS resource, as a coordinated TRP transmission direction for the terminal to coordinately transmit the PUSCH towards the plurality of TRP transmission directions.

In an implementation of the present disclosure, the second indication information includes a plurality pieces of indication information carried in a MAC-CE signaling, and each of the plurality pieces of indication information corresponds to one TRP transmission direction, or the second indication information includes one piece of indication information carried in the MAC-CE signaling, and the one piece of indication information corresponds to the plurality of TRP transmission directions.

In an implementation of the present disclosure, the apparatus for determining the uplink coordinated TRP further includes an obtaining unit, configured to obtain all or part of coordinated TRP transmission directions reported by the terminal.

According to a fourth aspect of embodiments of the present disclosure, there is provided an apparatus for determining an uplink coordinated TRP, including a processing unit, configured to determine a coordinated TRP based on one or more SRS resource sets, wherein the coordinated TRP is a TRP used by the terminal to coordinately transmit a PUSCH towards a plurality of TRP transmission directions.

In an implementation of the present disclosure, the processing unit determines a plurality of SRS resource sets through a higher layer signaling, wherein respective SRS resource sets of the plurality of SRS resource sets are correspondingly associated with different terminal panels or different TRP transmission directions.

The apparatus for determining the uplink coordinated TRP further includes an obtaining unit, configured to obtain first indication information. The processing unit uses, based on the first indication information, a terminal panel or a TRP transmission direction associated with part or all of the plurality of SRS resource sets as the coordinated TRP transmission direction for the terminal to coordinately transmit the PUSCH towards the plurality of TRP transmission directions.

In an implementation of the present disclosure, the first indication information includes a plurality pieces of indication information carried in a MAC-CE signaling, and each of the plurality pieces of indication information corresponds to one SRS resource set; or the first indication information includes one piece of indication information carried in the MAC-CE signaling, and the one piece of indication information corresponds to the plurality of SRS resource sets.

In an implementation of the present disclosure, the processing unit determines a plurality of SRS resource sets, wherein respective SRS resource sets of the plurality of SRS resource sets are correspondingly associated with different terminal panels or different TRP transmission directions; and selects, according to preset rule information, a terminal panel or a TRP transmission direction associated with part or all of the plurality of SRS resource sets as the coordinated TRP transmission direction for the terminal to coordinately transmit the PUSCH towards the plurality of TRP transmission directions.

In an implementation of the present disclosure, the plurality of SRS resource sets include a codebook transmission-based SRS resource set, and each SRS resource in the codebook transmission-based SRS resource set is configured with corresponding TRP transmission direction indication information.

In an implementation of the present disclosure, the plurality of SRS resource sets include a non-codebook transmission-based SRS resource set, and each SRS resource in the non-codebook transmission-based SRS resource set is configured with corresponding TRP transmission direction indication information or a CSI-RS associated with a corresponding TRP.

In an implementation of the present disclosure, the processing unit determines an SRS resource set for coordinately transmitting the PUSCH towards the plurality of TRP transmission directions, wherein each SRS resource in the SRS resource set is associated with the plurality of TRP transmission directions.

The apparatus for determining the uplink coordinated TRP further includes an obtaining unit, configured to obtain second indication information. The processing unit uses, based on the second indication information, part or all of the plurality of TRP transmission directions associated with the SRS resource as the coordinated TRP transmission direction for the terminal to coordinately transmit the PUSCH towards the plurality of TRP transmission directions.

In an implementation of the present disclosure, the second indication information includes a plurality pieces of indication information carried in a MAC-CE signaling, and each of the plurality pieces of indication information corresponds to one TRP transmission direction; or the second indication information includes one piece of indication information carried in the MAC-CE signaling, and the one piece of indication information corresponds to the plurality of TRP transmission directions.

In an implementation of the present disclosure, the processing unit determines an SRS resource set for coordinately transmitting the PUSCH towards the plurality of TRP transmission directions, wherein each SRS resource in the SRS resource set is associated with the plurality of TRP transmission directions, and selects, according to preset rule information, part or all of the plurality of TRP transmission directions associated with the SRS resource as the coordinated TRP transmission direction for the terminal to coordinately transmit the PUSCH towards the plurality of TRP transmission directions.

In an implementation of the present disclosure, the SRS resource set is a codebook transmission-based SRS resource set; and each SRS resource in the codebook transmission-based SRS resource set is configured with a plurality pieces of corresponding TRP transmission direction indication information.

In an implementation of the present disclosure, the SRS resource set is a non-codebook transmission-based SRS resource set, and each SRS resource in the non-codebook transmission-based SRS resource set is configured with a plurality pieces of corresponding TRP transmission direction indication information, or a plurality of CSI-RSs associated with a corresponding TRP.

In an implementation of the present disclosure, the apparatus for determining the uplink coordinated TRP further includes a reporting unit, configured to report all or part of the determined coordinated TRP transmission directions to a network device.

According to a fifth aspect of embodiments of the present disclosure, there is provided an apparatus for determining an uplink coordinated TRP, including a processor and a memory configured to store instructions executable by the processor. The processor is configured to execute the method for determining the uplink coordinated TRP described in the first aspect or any implementation of the first aspect.

According to a sixth aspect of embodiments of the present disclosure, there is provided an apparatus for determining an uplink coordinated TRP, including a processor and a memory configured to store instructions executable by the processor. The processor is configured to execute the method for determining the uplink coordinated TRP described in the second aspect or any implementation of the second aspect.

According to a seventh aspect of embodiments of the present disclosure, there is provided a non-transitory storage medium having instructions stored thereon, wherein the instructions in the non-transitory storage medium, when executed by a processor of a network device, enable the network device to perform the method for determining the uplink coordinated TRP described in the first aspect or any implementation of the first aspect.

According to an eighth aspect of embodiments of the present disclosure, there is provided a non-transitory storage medium having instructions stored thereon, wherein the instructions in the non-transitory storage medium, when executed by a processor of a terminal, enable the terminal to execute the method for determining the uplink coordinated TRP described in the second aspect or any implementation of the second aspect.

The technical solutions provided by embodiments of the present disclosure may include the following beneficial effects: based on the one or more SRS resource sets, the one or more TRP transmission directions are configured and determined, to determine the coordinated TRP used by the terminal to coordinately transmit the PUSCH towards the plurality of TRP transmission directions, achieving the dynamic selection of the uplink coordinated TRP.

It should be further understood that the term “a plurality of” or “a plurality of” in the present disclosure refers to two or more than two, and other quantifiers are similar. The term “and/or” describes an association relationship between associated objects, and represents that there may exist three relationships. For example, A and/or B may represent three conditions in which A independently exists, A and B both exist and B independently exists. The character “/” generally represents that the associated objects form an “or” relationship. The singular forms “a”, “the” and “said” are intended to include the plural forms as well, unless the context clearly indicates otherwise.

It should be further understood that, although the terms first, second, etc. may be configured to describe various information, such information should not be limited to these terms. These terms are only configured to distinguish the same type of information from each other, and do not imply a specific order or importance. In fact, expressions such as “first” and “second” can be used interchangeably For example, without departing from the scope of the present disclosure, the first information may also be referred to as the second information, and similarly, the second information may also be referred to as the first information.

It can be further understood that although the operations in embodiments of the present disclosure are described in a specific order in the drawings, they should not be understood as requiring that the operations should be performed in the specific order shown or in a serial order, or that perform all the operations shown to get the desired result. In certain environments, multitasking and parallel processing may be advantageous.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for determining an uplink coordinated Transmission Reception Point (TRP), performed by a network device, and comprising:
configuring and determining, based on one or more Sounding Reference Signal (SRS) resource sets, one or more TRP transmission directions;
wherein the one or more TRP transmission directions are configured to determine a coordinated TRP, and the coordinated TRP is a TRP used by a terminal to coordinately transmit a Physical Uplink Shared Channel (PUSCH) towards a plurality of TRP transmission directions.

2. The method for determining the uplink coordinated TRP according to claim 1, wherein the configuring and determining, based on the one or more SRS resource sets, the one or more TRP transmission directions comprises:
configuring a plurality of SRS resource sets through a higher layer signaling;
wherein respective SRS resource sets of the plurality of SRS resource sets are correspondingly associated with different terminal panels or different TRP transmission directions.

3. The method for determining the uplink coordinated TRP according to claim 2, wherein the plurality of SRS resource sets comprise a codebook transmission-based SRS resource set; and
each SRS resource in the codebook transmission-based SRS resource set is configured with corresponding TRP transmission direction indication information, or
wherein the plurality of SRS resource sets comprise a non-codebook transmission-based SRS resource set; and
each SRS resource in the non-codebook transmission-based SRS resource set is configured with the corresponding TRP transmission direction indication information or a Channel State Information Reference Signal (CSI-RS) associated with a corresponding TRP.

4. (canceled)

5. The method for determining the uplink coordinated TRP according to claim 2, wherein the method further comprises:
transmitting first indication information, wherein the first indication information is configured to indicate part or all of the plurality of SRS resource sets.

6. The method for determining the uplink coordinated TRP according to claim 5, wherein the first indication information comprises a plurality pieces of indication information carried in a Medium Access Control Control Element (MAC-CE) signaling, and each of the plurality pieces of indication information corresponds to one SRS resource set; or
the first indication information comprises one piece of indication information carried in the MAC-CE signaling, and the one piece of indication information corresponds to the plurality of SRS resource sets.

7. The method for determining the uplink coordinated TRP according to claim 1, wherein the configuring and determining, based on the one or more SRS resource sets, the one or more TRP transmission directions comprises:
configuring an SRS resource set for coordinately transmitting the PUSCH towards the plurality of TRP transmission directions;
wherein each SRS resource in the SRS resource set is configured to be associated with the plurality of TRP transmission directions.

8. The method for determining the uplink coordinated TRP according to claim 7, wherein the SRS resource set is a codebook transmission-based SRS resource set; and
each SRS resource in the codebook transmission-based SRS resource set is configured with the plurality of TRP transmission directions, or
wherein the SRS resource set is a non-codebook transmission-based SRS resource set; and
each SRS resource in the non-codebook transmission-based SRS resource set is configured with the plurality of TRP transmission directions, or a plurality of CSI-RSs associated with a plurality of corresponding TRPs.

9. (canceled)

10. The method for determining the uplink coordinated TRP according to claim 7, wherein the method further comprises:
transmitting second indication information, wherein the second indication information is configured to indicate part or all of the plurality of TRP transmission directions associated with the SRS resource, as a coordinated TRP transmission direction for the terminal to coordinately transmit the PUSCH towards the plurality of TRP transmission directions.

11. The method for determining the uplink coordinated TRP according to claim 10, wherein the second indication information comprises a plurality pieces of indication information carried in a MAC-CE signaling, and each of the plurality pieces of indication information corresponds to one TRP transmission direction; or
the second indication information comprises one piece of indication information carried in the MAC-CE signaling, and the one piece of indication information corresponds to the plurality of TRP transmission directions.

12. (canceled)

13. A method for determining an uplink coordinated Transmission Reception Point (TRP), performed by a terminal, and comprising:
determining, based on one or more Sounding Reference Signal (SRS) resource sets, a coordinated TRP transmission direction for coordinately transmitting a Physical Uplink Shared Channel (PUSCH) towards a plurality of TRP transmission directions, and a coordinated TRP, wherein the coordinated TRP is a TRP used by the terminal to coordinately transmit the PUSCH towards the plurality of TRP transmission directions.

14. The method for determining the uplink coordinated TRP according to claim 13, wherein the determining, based on the one or more SRS resource sets, the coordinated TRP transmission direction for coordinately transmitting the PUSCH towards the plurality of TRP transmission directions comprises:
determining a plurality of SRS resource sets through a higher layer signaling, wherein respective SRS resource sets of the plurality of SRS resource sets are correspondingly associated with different terminal panels or different TRP transmission directions; and
obtaining first indication information, and using, based on the first indication information, a terminal panel or a TRP transmission direction associated with part or all of the plurality of SRS resource sets as the coordinated TRP transmission direction for coordinately transmitting the PUSCH towards the plurality of TRP transmission directions.

15. The method for determining the uplink coordinated TRP according to claim 14, wherein the first indication information comprises a plurality pieces of indication information carried in a Medium Access Control Control Element (MAC-CE) signaling, and each of the plurality pieces of indication information corresponds to one SRS resource set; or
the first indication information comprises one piece of indication information carried in the MAC-CE signaling, and the one piece of indication information corresponds to the plurality of SRS resource sets; and
wherein the plurality of SRS resource sets comprise a codebook transmission-based SRS resource set, and each SRS resource in the codebook transmission-based SRS resource set is configured with corresponding TRP transmission direction indication information; or
wherein the plurality of SRS resource sets comprise a non-codebook transmission-based SRS resource set; and each SRS resource in the non-codebook transmission-based SRS resource set is configured with the corresponding TRP transmission direction indication information or a Channel State Information Reference Signal (CSI-RS) associated with a corresponding TRP.

16. The method for determining the uplink coordinated TRP according to claim 13, wherein the determining, based on the one or more SRS resource sets, the coordinated TRP transmission direction for coordinately transmitting the PUSCH towards the plurality of TRP transmission directions comprises:
determining a plurality of SRS resource sets through a higher layer signaling, wherein respective SRS resource sets of the plurality of SRS resource sets are correspondingly associated with different terminal panels or different TRP transmission directions; and
selecting, according to preset rule information, a terminal panel or a TRP transmission direction associated with part or all of the plurality of SRS resource sets as the coordinated TRP transmission direction for coordinately transmitting the PUSCH towards the plurality of TRP transmission directions; and
wherein the plurality of SRS resource sets comprise a codebook transmission-based SRS resource set, and each SRS resource in the codebook transmission-based SRS resource set is configured with corresponding TRP transmission direction indication information; or
wherein the plurality of SRS resource sets comprise a non-codebook transmission-based SRS resource set; and each SRS resource in the non-codebook transmission-based SRS resource set is configured with the corresponding TRP transmission direction indication information or a Channel State Information Reference Signal (CSI-RS) associated with a corresponding TRP.

17-18. (canceled)

19. The method for determining the uplink coordinated TRP according to claim 13, wherein the determining, based on the one or more SRS resource sets, the coordinated TRP transmission direction for coordinately transmitting the PUSCH towards the plurality of TRP transmission directions comprises:
determining an SRS resource set for coordinately transmitting the PUSCH towards the plurality of TRP transmission directions, wherein each SRS resource in the SRS resource set is associated with the plurality of TRP transmission directions; and
obtaining second indication information, and using, based on the second indication information, part or all of the plurality of TRP transmission directions associated with the SRS resource as the coordinated TRP transmission direction for the terminal-te coordinately transmitting the PUSCH towards the plurality of TRP transmission directions.

20. The method for determining the uplink coordinated TRP according to claim 19, wherein the second indication information comprises a plurality pieces of indication information carried in a MAC-CE signaling, and each of the plurality pieces of indication information corresponds to one TRP transmission direction; or
the second indication information comprises one piece of indication information carried in the MAC-CE signaling, and the one piece of indication information corresponds to the plurality of TRP transmission directions; and
wherein the SRS resource set is a codebook transmission-based SRS resource set; and each SRS resource in the codebook transmission-based SRS resource set is configured with a plurality pieces of corresponding TRP transmission direction indication information; or
wherein the SRS resource set is a non-codebook transmission-based SRS resource set; and each SRS resource in the non-codebook transmission-based SRS resource set is configured with the plurality pieces of corresponding TRP transmission direction indication information, or a plurality of CSI-RSs associated with a corresponding TRP.

21. The method for determining the uplink coordinated TRP according to claim 13, wherein the determining, based on the one or more SRS resource sets, the coordinated TRP transmission direction for coordinately transmitting the PUSCH towards the plurality of TRP transmission directions comprises:
determining an SRS resource set for coordinately transmitting the PUSCH towards the plurality of TRP transmission directions, wherein each SRS resource in the SRS resource set is associated with the plurality of TRP transmission directions;
selecting, according to preset rule information, part or all of the plurality of TRP transmission directions associated with the SRS resource as the coordinated TRP transmission direction for coordinately transmitting the PUSCH towards the plurality of TRP transmission directions; and
wherein the SRS resource set is a codebook transmission-based SRS resource set; and each SRS resource in the codebook transmission-based SRS resource set is configured with a plurality pieces of corresponding TRP transmission direction indication information; or
wherein the SRS resource set is a non-codebook transmission-based SRS resource set; and each SRS resource in the non-codebook transmission-based SRS resource set is configured with the plurality pieces of corresponding TRP transmission direction indication information, or a plurality of CSI-RSs associated with a corresponding TRP.

22-26. (canceled)

27. An apparatus for determining an uplink coordinated Transmission Reception Point (TRP), comprising:
a processor; and
a memory, configure to store instructions executable by the processor;
wherein the processor is configured to:
configure and determine, based on one or more Sounding Reference Signal (SRS) resource sets, one or more TRP transmission directions;
wherein the one or more TRP transmission directions are configured to determine a coordinated TRP, and the coordinated TRP is a TRP used by a terminal to coordinately transmit a Physical Uplink Shared Channel (PUSCH) towards a plurality of TRP transmission directions.

28. A non-transitory storage medium having instructions stored thereon, wherein the instructions in the non-transitory storage medium, when executed by a processor of a network device, enable the network device to perform the method for determining the uplink coordinated TRP according to claim 1.

29. An apparatus for determining an uplink coordinated Transmission Reception Point (TRP), comprising:
a processor; and
a memory, configure to store instructions executable by the processor;
wherein the processor is configured to perform the method for determining the uplink coordinated TRP according to claim 13.

30. A non-transitory storage medium having instructions stored thereon, wherein the instructions in the non-transitory storage medium, when executed by a processor of a network device, enable the network device to perform the method for determining the uplink coordinated TRP according to claim 13.
